(19) United States
(12) Patent Application Publication
(10) Pub. No.: US 2009/0034378 A1
(43) Pub. Date: Feb. 5, 2009

(54) Method for Data Access and Optical Data Accessing Apparatus Therefor

(75) Inventors: Gwo-Huei Wu, Pan-Chiao City (TW); Ching-Ning Chiu, Chu-Pei City (TW); Hsiang-Ji Hsieh, Jhubei City (TW); Chih-Yuan Chen, Hsin-Chu City (TW); Shih-Jung Chiu, Tainan County (TW)

Correspondence Address: GROSSMAN, TUCKER, PERREAULT & PFLEGER, PLLC, 55 SOUTH COMMERICAL STREET, MANCHESTER, NH, 03101, US

(73) Assignee: MEDIATEK INC., Hsinchu (TW)

(21) Appl. No.: 12/176,599

(22) Filed: Jul. 21, 2008

(30) Foreign Application Priority Data
Jul. 30, 2007 (TW) 096127747

(51) Int. Cl. G11B 5/09; G11B 3/74

(52) U.S. Cl. 369/47.14; 369/94

(57) ABSTRACT

An optical data accessing apparatus and method for changing the access from a first data layer to a second data layer of an optical storage medium are provided. The first data layer corresponds to a first SAC value, while the second data layer corresponds to a second SAC value. A processor of the optical data accessing apparatus is adapted for: (1) generating and sending a focus off signal to a pickup control unit to disable focus control; (2) generating a target value for an SAC to adjust an SAC value from the first SAC value to the target value, wherein the target value is between the first SAC value and the second SAC value; and (3) generating and sending a focus activation signal to the pickup control unit to re-enable the focus control to focus on the second data layer while the SAC value reaches the target value.

This application claims the benefit of priority based on Taiwan Patent Application No. 096127747, filed on Jul. 30, 2007, the contents of which are incorporated herein by reference in their entirety.

### CROSS-REFERENCES TO RELATED APPLICATIONS

Not applicable.

### BACKGROUND OF THE INVENTION

1. Field of the Invention

The present invention relates to a method and apparatus for changing the data access from a first data layer to a second data layer in a plurality of data layers of an optical storage medium. More, specifically, the method and apparatus reduces the time needed for changing focus on the data layer by adjusting the focusing time and the spherical aberration compensation (SAC) time.

2. Descriptions of the Related Art

With the rapid development of optical data accessing apparatuses, the functionality of various optical data accessing apparatuses are becoming increasingly sophisticated. Those optical data accessing apparatuses that can access an optical storage medium with multiple data layers have become a focus of technical development for numerous manufacturers.

FIG. 1 is a schematic diagram illustrating an optical data accessing apparatus how to read data on an optical storage medium 10. The optical storage medium 10 comprises two data layers: a first data layer 101 and second data layer 103. The optical data accessing apparatus comprises a focusing element 113 and a spherical aberration compensator (SAC) 115. The focusing element 113 is adapted to focus a laser beam 111 on the first data layer 101 or the second data layer 103 to access data thereon, while the SAC 115 is adapted to compensate for the optical spherical aberration.

As shown in FIG. 1, the laser beam 111 focuses on the second data layer 103 to access the data thereon. When the optical data accessing apparatus needs to access data stored on the first data layer 101, a readjustment should be made simultaneously on both the focusing element 113 and the SAC 115. Because the SAC 115 is typically driven by a step motor, which is incapable of driving the SAC 115 to a desired position rapidly enough, a micro liquid crystal device (LCD) is used in some optical data accessing apparatuses to compensate for the spherical aberration.

Although time may be saved by using the micro LCD to compensate for the spherical aberration than by using a step motor, there is still a great room for improvement for the modern optical data accessing apparatuses that need high data accessing speeds. Accordingly, it is important to considerably reduce the latency time needed to re-focus and compensate for the spherical aberration during the target data layer change.

### SUMMARY OF THE INVENTION

One embodiment of this invention is to provide a method for data access for changing access from a first data layer to a second data layer between a plurality of data layers of an optical storage medium. The method is used in an optical data accessing apparatus. The optical data accessing apparatus controls a beam to generate a focus point on the data layers by a focus control, and compensates for a spherical aberration of the focus point by using a spherical aberration compensation (SAC) value. The first data layer corresponds to a first SAC value, while the second data layer corresponds to a second SAC value. The method comprises the following steps: disabling the focus control; adjusting the SAC value from the first SAC value to a target value, wherein the target value is between the first SAC value and the second SAC value; and re-enabling the focus control for controlling the focus point to focus on the second data layer when the SAC value reaches the target value.

Another embodiment of this invention is to provide an optical data accessing apparatus for changing access from a first data layer to a second data layer of a plurality of data layers of an optical storage medium. The first data layer corresponds to a first SAC value, while the second data layer corresponds to a second SAC value. The optical data accessing apparatus comprises an optical pickup head, a signal processing unit, a pickup control unit, and a processor. The optical pickup head is configured to generate a beam to focus on the optical storage medium, and comprises an object lens, a photodetector, and a spherical aberration compensator (SAC). The object lens is configured to control a focus point of the beam; the photodetector is configured to detect a reflected light reflected from the optical storage medium. The SAC is configured to compensate a spherical aberration of the beam according to the SAC values.

The signal processing unit is configured to generate a focusing error (FE) signal according to the reflected light. The pickup control unit is configured to execute a focus control according to the FE signal to focus the focus point on the data layers. The processor is configured to do the following: (1) generate a focus off signal to the pickup control unit to disable the focus control; (2) generate a target value for the SAC to adjust the SAC value from the first SAC value to the target value, wherein the target value is between the first SAC value and the second SAC value; and (3) generate a focus activation signal to the pickup control unit to re-enable the focus control for controlling the focus point to focus on the second data layer when the SAC value reaches the target value.

A further embodiment of this invention is to provide a method for data access for changing access from a first storage region of an optical storage medium to a second storage region of the same. The method is used in an optical data accessing apparatus. The first storage region is positioned in a first data layer of the optical storage medium, while the second storage region is positioned in a second data layer of the optical storage medium. The optical data accessing apparatus is configured to control a beam to generate a focus point on the data layers by using a focus control and to compensate for a spherical aberration of the focus point by an SAC value. The first data layer corresponds to a first SAC value, while the second data layer corresponds to a second SAC value. The method comprises the following steps: disabling the focus control; determining whether the changing access from the first storage region to the second storage region is a long distance movement; adjusting the SAC value from the first SAC value to a target value and moving an accessing position of the first storage region to an accessing position of the second storage region when the changing access which is from the first storage region to the second storage region is the long distance, wherein the target value is between the first SAC value and the second SAC value; and re-enabling the focus control for controlling the focus point to focus on the second data layer when the SAC value reaches the target value.

On the other hand, if the changing access from the first storage region to the second storage region is not long distance, the method comprises the following steps: adjusting the SAC value from the first SAC value to the target value; adjusting the SAC value from the target value to the second SAC value; and moving the accessing position of the first storage region to the accessing position of the second storage region after the SAC value is adjusted to the second SAC value.

Yet a further objective of this invention is to provide an optical data accessing apparatus for changing access from a first storage region of an optical storage medium to a second storage region of the same. The first storage region is positioned in a first data layer of the optical storage medium, while the second storage region is positioned in a second data layer of the optical storage medium. The first data layer corresponds to a first SAC value, while the second data layer corresponds to a second SAC value. The optical data accessing apparatus comprises an optical pickup head, a signal processing unit, a pickup control unit, and a processor. The optical pickup head is configured to generate a beam to focus on the optical storage medium, and comprises an object lens, a photodetector, and an SAC. The object lens is configured to control a focus point of the beam. The photodetector is configured to detect a reflected light reflected from the optical storage medium. The SAC is configured to compensate for a spherical aberration of the beam according to the SAC values.

The signal processing unit is configured to generate an FE signal according to the reflected light. The pickup control unit is configured to execute a focus control according to the FE signal to focus the focus point on the data layers. The processor is configured to do the following: (1) generate a focus off signal to the pickup control unit to disable the focus control; (2) determine whether the changing access from the first storage region to the second storage region is a long distance movement; (3) generate a target value for the SAC to adjust the SAC value from the first SAC value to the target value and to move an accessing position of the first storage region to an accessing position of the second storage region when the changing access from the first storage region to the second storage region is a long distance, wherein the target value is between the first SAC value and the second SAC value; and (4) generate a focus activation signal to the pickup control unit to re-enable the focus control for controlling the focus point to focus on the second data layer when the SAC value reaches the target value.

On the other hand, if the changing access from the first storage region to the second storage region is not the long distance movement, the processor is configured to do the following: adjust the SAC value from the first SAC value to the target value; adjust the SAC value from the target value to the second SAC value; and move the accessing position of the first storage region to the accessing position of the second storage region after the SAC value is adjusted to the second SAC value.

With the methods and optical data accessing apparatuses of this invention, the latency time needed to re-focus and compensate for the spherical aberration during the changing of the target data layer is reduced.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic diagram illustrating an optical data accessing apparatus how to read data from an optical storage medium;

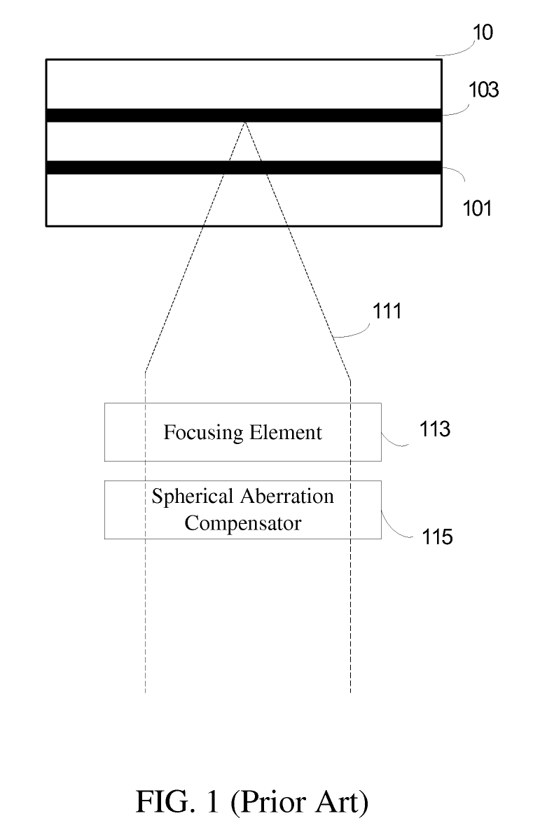

FIG. 2 is a schematic diagram illustrating a first embodiment of this invention;

FIG. 3 is a flow chart of a process for obtaining the SACn, FEGn, FEOn values and the predetermined values of each layer in accordance with the first embodiment of this invention;

FIG. 4 is a schematic diagram illustrating how the S-curves are generated in the first embodiment of this invention;

FIG. 5 is a schematic diagram illustrating the operations that enable the focus control to focus on the second data layer when making the spherical aberration compensation with the target value in accordance with the first embodiment of this invention;

FIG. 6 is a schematic diagram illustrating the operations of changing data access from a first data layer to a second data layer in accordance with the first embodiment of this invention;

FIG. 7 is a schematic diagram illustrating the time durations when changing a data layer and a tracking position with long-distance movement in accordance with the first embodiment of this invention;

FIG. 8 is a schematic diagram illustrating the time durations when changing a data layer and a tracking position with short-distance movement in accordance with the first embodiment of this invention;

FIG. 9 and FIG. 10 are flow charts of a complete data accessing process in accordance with the first embodiment of this invention; and

FIG. 11 is a flow chart of a method in accordance with a second embodiment of this invention.

### DESCRIPTION OF THE PREFERRED EMBODIMENT

This invention applies to an optical data accessing apparatus. For example, this invention applies to an optical disk driver. The invention allows the optical data accessing apparatus can focus rapidly on different data layers of an optical storage medium (e.g., an optical disk) as desired to reduce the latency time needed to change a target data layer.

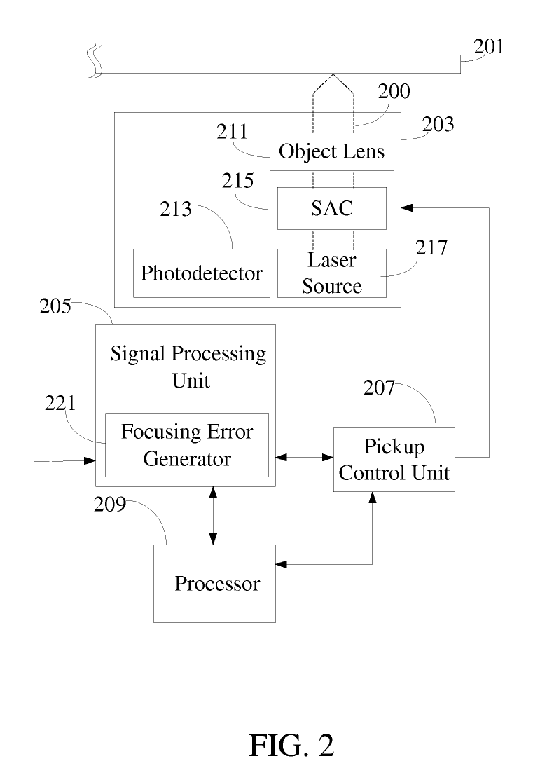

A first embodiment of this invention is an optical disk driver for accessing data on a blu-ray optical disk. A blu-ray optical disc has a plurality of data layers (Ln), in which each of the data layers is adapted to store data thereon. The notation “n” refers to the number of data layers. As shown in FIG. 2, the optical disk driver comprises an optical pickup head 203, a signal processing unit 205, a pickup control unit 207, and a processor 209. The optical pickup head 203 comprises an object lens (i.e. a focusing element) 211, a photodetector 213, an spherical aberration compensator (SAC) 215, and a laser source 217. The laser source 217 is configured to generate a beam 200, while the object lens 211 is configured to control a focus point of the beam 200 to focus on the data layers. The photodetector 213 is configured to detect a reflected light reflected from a blu-ray optical disc 201, while the SAC 215 is configured to compensate for a spherical aberration of the beam 200 according to an SAC value. The signal processing unit 205 comprises a focusing error (FE) generator 221, which is configured to generate an FE signal according to the reflected light. Due to the optical characteristics of the blu-ray optical disc 201, when the focus point of the beam 200 scans through any of the data layers, a so-called “S-curve” will be generated in the FE signal. The pickup control unit 207 is configured to execute a focus control according to the FE signal to focus on the data layers.

In the first embodiment, when accessing from a first data layer is changed to a second data layer between a plurality of data layers of the blu-ray optical disk 201, a focus off signal is generated by the processor 209. Then, the focus off signal is inputted into the pickup control unit 207 to disable the focus control. At this point, the object lens 211 moves (focus) its focus point to a predetermined position, which may be a position on a cover layer (i.e., focus to the cover layer) of the blu-ray optical disk 201 or even outside the blu-ray optical disk 201. Then, the processor 209 generates a target value, so that the SAC 215 adjusts the SAC value from an SAC value of the first data layer (i.e. the first SAC value) to the target value, wherein the target value is between the first SAC value and an SAC value of the second data layer (i.e. the second SAC value). When the SAC value reaches the target value, a focus activation signal is generated by the processor 209 for input into the pickup control unit 207 to re-enable the focus control for focusing on the second data layer.

More specifically, by controlling an SAC value (SACn), a focus error gain (FEGn) value, and a focus error offset (FEOn) value, the processor 209 directs the pickup control unit 207 to generate a focusing output (FOO) signal according to the FE signal to control the object lens 211 to focus the beam 200 onto the data layers. The processor 209 then determines whether the focus point is approaching the second data layer by determining whether the level of the EF signal is greater than a predetermined value.

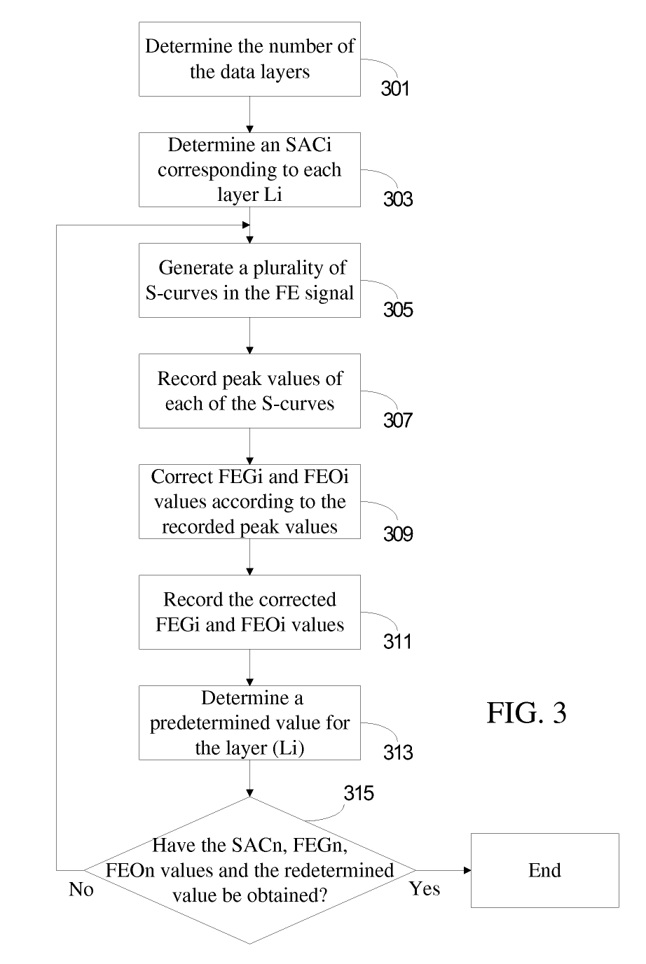

FIG. 3 is a flow chart illustrating the process for obtaining the SACn, FEGn, FEOn values and predetermined value of each data layer. Initially in step 301, the processor 209 determines the number of the data layers, that is, the maximum value of n. Then, in step 303, a plurality of SAC values are transmitted from the pickup control unit 207 to the SAC 215 to determine an SACi corresponding to each layer Li. This step may be accomplished by a common spherical aberrations correction process. For example, the SAC value is increased or decreased accordingly while the beam 200 is focused on each individual layer Li respectively. Then, the value resulting in the minimum jitter or the minimum error rate can be determined as the SACi value corresponding to the layer Li. In other words, the first SAC value and the second SAC value can be determined in step 303.

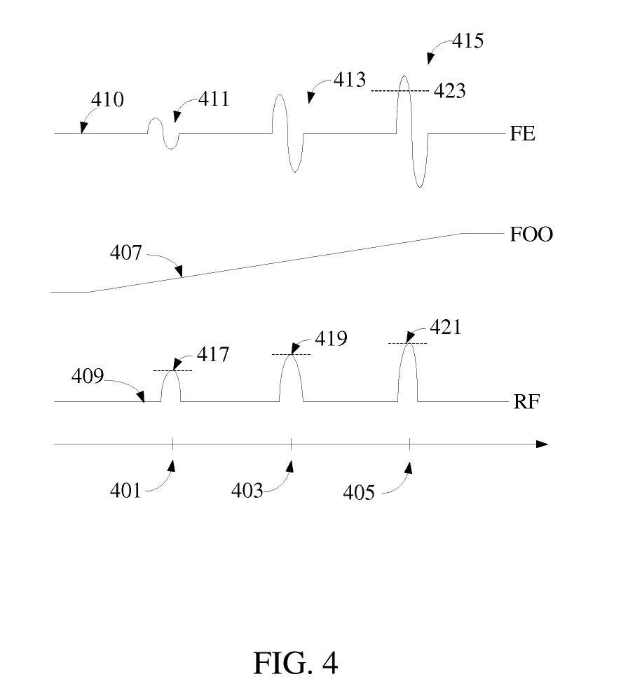

Next, in step 305, the object lens 211 controls the focus point to pass through each of the data layers respectively to generate a plurality of S-curves in the FE signal. FIG. 4 illustrates two data layers, in which the horizontal axis represents time and the longitudinal axis represents voltage levels of respective signals. However, the signals plotted at the top are not limited to having a higher voltage than those at the bottom. Instead, the FE signal 410, FOO signal 407, and aggregate signal (RF) 409 are arranged along the same longitudinal axis for simplicity. The reference numeral 401 denotes the time instant when the original focus point is focused on the cover layer, while 403 denotes the time instant when the beam is focused on the first data layer, and 405 denotes the time instant when the beam is focused on the second data layer.

The FOO signal 407 stays at its minimum value for the beam 200 to focus on an original position. Then, as a focus controller (not shown) in the pickup control unit 207 incrementally increases its voltage level, the object lens 211 begins to move. Once the object lens 211 moves to a position where the beam 200 is focused on the cover layer (i.e. 401), a first voltage level 417 will be generated in the RF signal 409 according to the optical characteristics. Correspondingly, a first S-curve 411 is generated in the FE signal 410. As the voltage level of the FOO signal 407 continues to rise so that the beam 200 is focused on the first data layer (i.e. 403), a second voltage level 419 will be generated in the RF signal 409. Correspondingly, a second S-curve 413 is generated in the FE signal 410. Similarly, as the voltage level of the FOO signal 407 continues to further rise so that the beam 200 is focused on the second data layer (i.e. 405), a third voltage level 421 will be generated in the aggregate signal 409, and correspondingly, a third S-curve 415 is generated in the FE signal 410. Thus, a number of S-curves are generated.

Next in step 307, peak values of each S-curve are recorded; that is, the peak values of the first S-curve 411, the second S-curve 413, and the third S-curve 415 are recorded by the processor 209. In step 309, FEGi and FEOi values are corrected according to the recorded peak values, while the corrected FEGi and FEOi values are recorded again by the processor 209 in step 311. Then, in step 313, the processor 209 determines a predetermined value for this layer (Li) according to the recorded EFGi and FEOi values. For example, the predetermined value of the second data layer may be an average between the peak values of the second S-curve 413 and the third S-curve 415. The average is denoted by the reference numeral 423 in FIG. 4.

Then, the process proceeds to step 315, where the processor 209 determines whether the SACn, FEGn, FEOn values and the predetermined value of the layer Ln have all be obtained. If not, then the process returns to step 305 to select one of the layers in which these values have not yet been obtained, and set a SAC value corresponding to this layer. Then, steps 307 to 313 are executed to obtain the FEGi value, FEOi value, and predetermined value of this layer. On the other hand, if it is determined in step 315 that the SACn, FEGn, FEOn values and the predetermined value have been obtained for all the layers, the process comes to end.

When the optical disk driver is accessing data stored on the first data layer, the focusing point is positioned on the first data layer and the SAC value is the first SAC value. When the accessing operation is changed to the second data layer, the processor 209 first disables the focus control, so that an FE signal generated in response to the reflected light will not have any influence on the subsequent changing operation. Thereafter, the processor 209 adjusts the SAC value from the first SAC value to a target value, which is between the first SAC value and the second SAC value. Once the SAC value reaches the target value, the processor 209 will re-enable the focus control to control the focus point to focus on the second data layer. In summary, in the first embodiment, while the SAC 215 is making an adjustment to compensate for the second data layer, the focus point is focused on the second data layer at a midpoint of this course (i.e., when the SAC value is adjusted to the target value). Once the SAC value reaches the second SAC value, the optical disk driver can access data on the second data layer immediately. Upon completion of the SAC adjustment, the optical disk driver can access data on the second data layer without needing to wait for the completion of the focus adjustment. Then, the latency time needed to re-focus and compensate for the spherical aberration will be reduced when changing a target data layer.

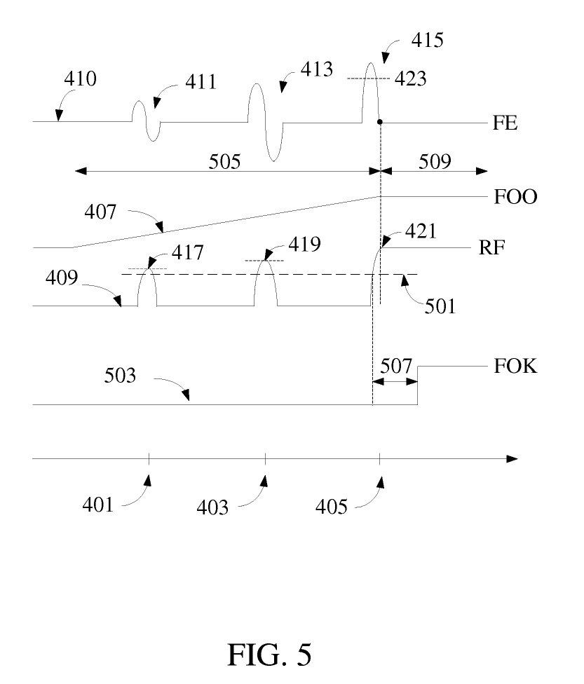

FIG. 5 is used to illustrate operations of the pickup control unit 207 to re-enable the focus control to focus on the second data layer when compensating for the spherical aberration with the target value. Similarly, the horizontal axis represents time, while the longitudinal axis represents the voltage levels of the respective signals. However, the signals plotted at the top are not limited to having a higher voltage than those at the bottom. Rather, the FE signal 410, the FOO signal 407, the aggregate signal (RF) 409, and the focus confirmation signal (FOK) 503 are arranged along the same longitudinal axis only for simplicity. Once information about the first, second and third levels 417, 419, 421 as well as the first, second and third S-curves 411, 413, 415 are obtained, the optical disk driver can determine a focusing position on the second data layer according to the information about the levels and the S-curves. As shown in FIG. 5, the third S-curve 415 has the maximum peak value, the first S-curve 411 has the smallest peak value, and the second S-curve 413 has the second maximum peak value which is located between the maximum peak value and the smallest peak value when the SAC 215 compensates the SA with the second SAC value. Therefore, as the FOO signal 407 increases its level continuously, the FE signal 410 will exceed the predetermined value 423, which indicates that the FE signal 410 is approaching a central point of the third S-curve 415, i.e., the focus point of the beam 200 is approaching the second data layer. At this point, the object lens 211 begins to decelerate, so that the FE signal 410 comes to a standstill exactly at the central point of the third S-curve 415; that is, the focus point of the beam 200 is focused exactly on the second data layer. This stage 505 described above is called a focus search stage.

More specifically, as shown in FIG. 5, when the level of the RF signal 409 goes higher than a focus confirmation value 501 for a certain time period, a focus confirmation signal 503 will turn into a high level. In the previous stage 505, although both the first level 417 and the second level 419 are higher than the focus confirmation value 501, neither the first S-curve 411 or the second S-curve 413 is higher than the predetermined value 423. As a result, the FOO signal 407 continues to rise in level. The duration of the RF signal 409 which has been higher than the focus confirmation value is not longer than the aforesaid certain time period, so that the focus confirmation signal 503 will not turn into a high level.

Once the focus point of the beam 200 is focused onto the second data layer, the photodetector 213 can obtain a signal carrying data of the second data layer, and therefore the RF signal 409 will be maintained at the third level 421. This stage 509 is called a focus-on stage. In this stage, because the RF signal 409 has been maintained at the third level 421 for a duration exceeding the aforesaid certain time period (i.e. a time zone 507), the focus confirmation signal 503 turns into a high level, which indicates that the focus point has been focused successfully onto the second data layer. In this embodiment, the focus confirmation signal 503 may also prevent the object lens 211 from impinging on the blu-ray optical disk 201. For example, if the RF signal 409 goes lower than the focus confirmation value 501 abruptly for a certain time period, the focus confirmation signal 503 will turn into a low level. In response to this, the pickup control unit 207 will disable the focus control to prevent the object lens 211 from impinging on the blu-ray optical disk 201 due to re-focusing.

Apart from using the level of the focusing signal as a basis for determining if the second data layer has been focused on, the number of S-curves may also be used to judge the focusing occasion in this invention. For example, assuming that the second data layer is the second layer of the blu-ray optical disk, once a third S-curve occurs in the focusing signal, the focus point can be focused onto the second data layer. On the other hand, if the focus needs to be on the first data layer, the timing for focusing on the first data layer is determined when the second S-curve occurs. In summary, in accordance with the embodiment of this invention, the beam that has been focused on the second data layer may be determined by a predetermined condition of the FE signal. The predetermined condition may be that a level of the FE signal is greater than a predetermined value or the number of S-curves in the FE signal reaches a predetermined number.

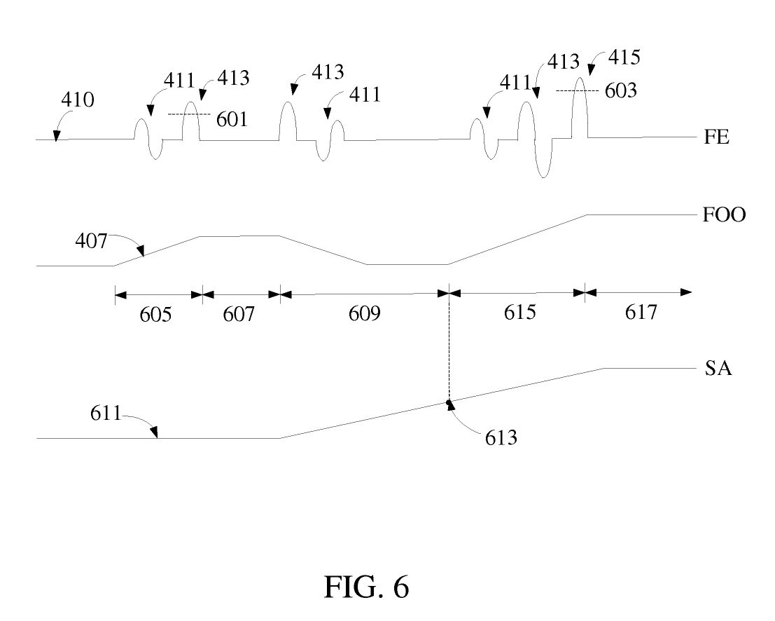

FIG. 6 is used to illustrate the operations of an optical disk driver when accessing data on the first data layer and then changing data access to the second data layer. Similarly, the horizontal axis represents time, while the longitudinal axis represents the voltage levels of respective signals. However, the signals plotted at the top are not limited to having a higher voltage than those at the bottom. Rather, the FE signal 410, the FOO signal 407, and the compensation value signal (SA) 611 are arranged along the same longitudinal axis only for simplicity. Initially, the pickup control unit 207 controls the object lens 211 to perform a focus search. Assuming that the compensation value 611 is the first SAC value, while the FOO signal 407 has its level increased continuously. Then, the first S-curve 411 occurs first in the FE signal 410, followed by the second S-curve 413, which has a peak value higher than a first predetermined value 601 of the first data layer (a focus search stage 605). Once the FE signal 410 exceeds the first predetermined value 601, the process proceeds to a focus-on stage 607. In this stage, the beam is focused onto the first data layer, while the FOO signal 407 remains unchanged, the optical disk driver begins to access data on the first data layer. When the data access is completed on the first data layer and is changed to the second data layer, the processor 209 generates a focus off signal to disable the focus control. In response to this, the FOO signal 407 has its level decreased to move the focus point of the object lens 211 outside the blu-ray optical disk 201. At the same time, the compensation value 611 begins to change from the first SAC value to the second SAC value (a focus-off stage 609). Once the compensation value 611 reaches a target value 613, the processor 209 re-enables the focus search stage (stage 615). At this time, the compensation value 611 is adjusted to the second SAC value. The FOO signal 407 also increases its level again. Then, the first S-curve 411 occurs first in the FE signal 410, followed by the second S-curve 413, and finally comes the third S-curve 415, which has a peak value higher than a second predetermined value 603 of the second data layer. Once the level of the FE signal 410 exceeds the second predetermined value 603, the process proceeds to a focus-on stage 617. In this stage, when the beam is focused on the second data layer, and the FOO signal 407 remains unchanged, then the optical disk driver begins to access data on the second data layer.

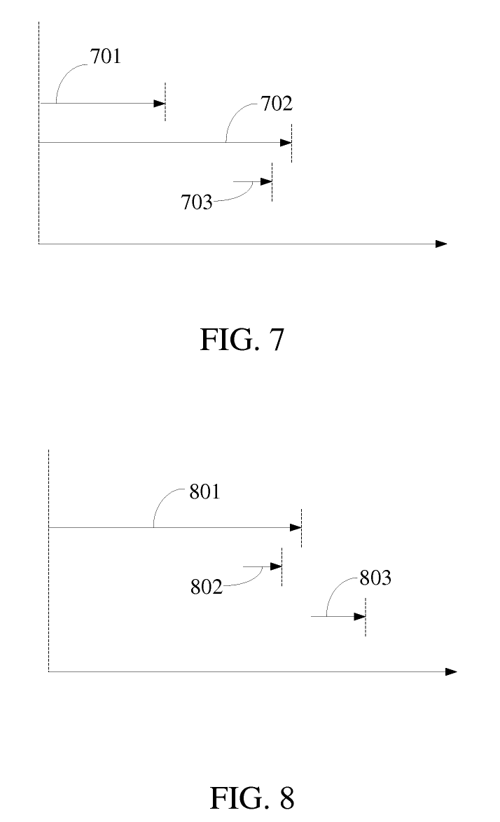

Generally, each of the data layers has a number of storage regions. Therefore, in this embodiment, the time needed to change between the different tracks (i.e., the optical pickup head 203 moves from one storage region to another) may also be considered during the changing of a target layer. In this embodiment, when the optical disk driver changes data access from a first storage region of the first data layer to a second storage region of the second data layer, the optical disc drive would also judge whether the movement is long distance. If the optical pickup head 203 needs a long distance lateral movement (i.e. more than 1000 tracks), a longer time will be needed to complete such a lateral movement, in which case the optical pickup head 203 will begin to move towards the second storage region while the compensation value is being adjusted. FIG. 7 is a schematic diagram illustrating the time durations needed to change a data layer and storage region in long-distance movement. The horizontal axis represents time. The reference numeral 701 represents the time spent on the long-distance movement, the reference numeral 702 represents the time spent on compensating for the spherical aberration by the SAC 215 during a layer changing process, i.e. the time spent in changing from the first SAC value to the second SAC value, and the reference numeral 703 represents the time spent in re-enabling the object lens 211 to focus on the second data layer. As shown in this figure, the long-distance movement and the compensation are started simultaneously, thereby, saving time.

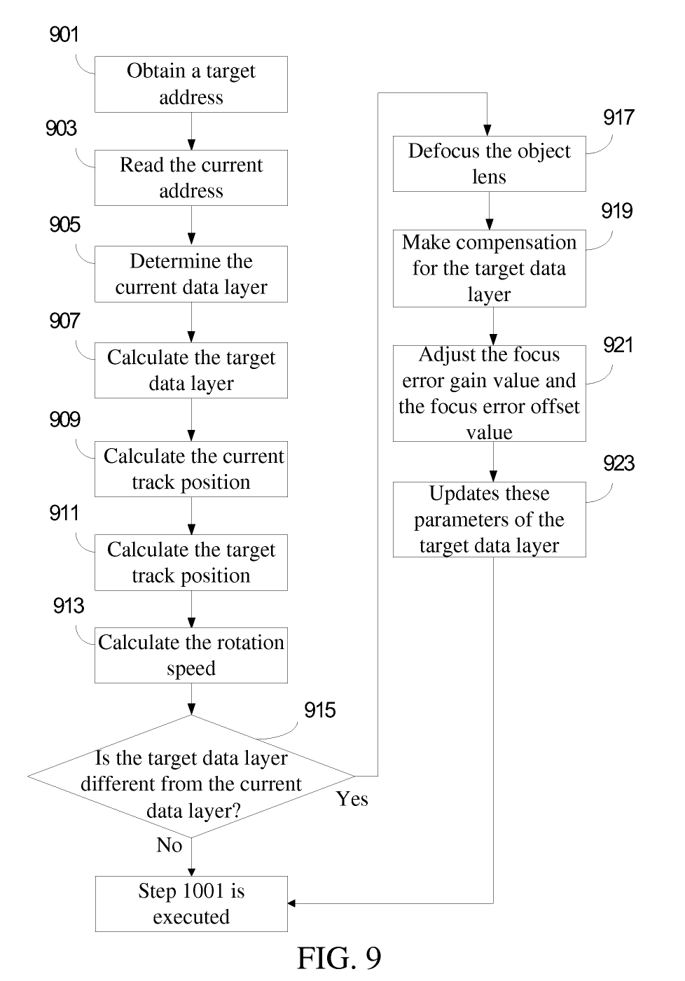

On the other hand, if the movement of the optical pickup head 203 towards the second storage region is short distanced, which means a short time is needed for the lateral movement of the optical pickup head 203, then the movement towards the second storage region can be started after the compensation value has been adjusted to the second SAC value. FIG. 8 is a schematic diagram illustrating the time durations needed to change a data layer and storage region in short-distance movement. The horizontal axis represents time. The reference numeral 801 represents the time spent on compensating for the spherical aberration by the SAC 215 during a layer changing process, the reference numeral 802 represents the time spent in re-enabling the object lens 211 to focus on the second data layer, and the reference numeral 803 represents the time spent on the short-distance movement. As shown in this figure, the short-distance movement is not started until the compensation is completed.

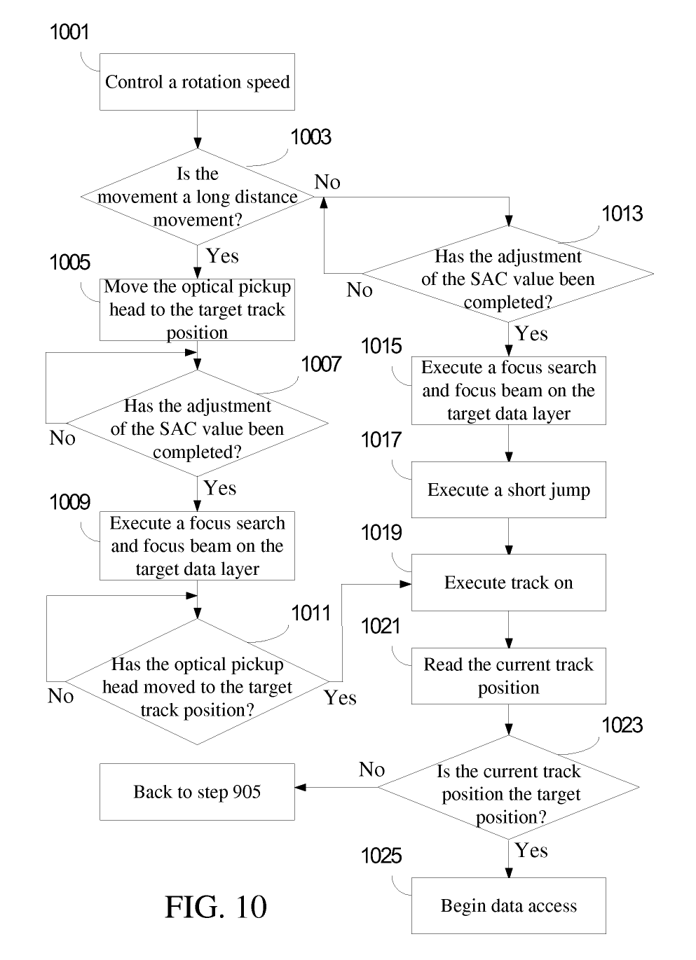

FIG. 9 and FIG. 10 illustrate flow charts of the complete data access process of the first embodiment, which is primarily executed and controlled by the processor 209. Initially in step 901, the processor 209 obtains a target address, and then in step 903, the processor 209 reads the current address. Next, in step 905, the processor 209 determines the current data layer. Subsequently, the processor 209 calculates the target data layer according to the target address in step 907, and calculates the current track position in step 909. Thereafter, the processor 209 calculates the target track position according to the target address in step 911, and calculates the rotation speed needed to read data on the target track position in step 913.

Next in step 915, the processor 209 determines whether the target data layer is different from the current data layer. If so, the processor 209 controls the pickup control unit 207 to transmit a signal that defocuses the object lens 211 in step 917, and then controls the pickup control unit 207 to transmit a signal enabling the SAC 215 to compensate for the target data layer in step 919. Afterwards, the processor 209 adjusts both the focus error gain (FEG) value and the focus error offset (FEO) value to a target FEG value and a target FEO value respectively in step 921. The parameters of the target data layer are updated in a memory in step 923. Then, the process proceeds to step 1001. On the other hand, if in step 915, the target data layer is the current data layer, the data layer does not need to be changed. As a result, the process proceeds directly to step 1001.

In step 1001, the processor 209 controls the pickup control unit 207 to transmit a signal, which drives the rotation speed of the blu-ray optical disk 201 to reach a rotation speed needed to read the data on the target track position. Then, in step 1003, the processor 209 determines whether the movement from the current track position to the target track position is long distance, (i.e. a long jump). If so, then in step 1005, the processor 209 controls the pickup control unit 207 to transmit a signal which directs the optical pickup head 203 to move laterally to the target track position. Next in step 1007, the processor 209 determines that the adjustment of the SAC value has been completed. If the SAC value has been adjusted, the process proceeds to step 1009, where a focus search is performed and the beam 200 is focused on the target data layer. Otherwise, execution of step 1007 will be resumed after a certain time period until the adjustment of the SAC value is completed. Then, the process proceeds to step 1011, where the processor 209 determines whether the optical pickup head 203 has moved to the target track position. If not, then the execution of step 1011 will be resumed after a certain time period, until the optical pickup head 203 has moved to the target track position.

If the movement from the current track position to the target track position is determined to not be a long jump in step 1003, step 1013 is executed for the processor 209 to determine whether the SAC value has been adjusted. If the SAC value has been adjusted, the process proceeds to step 1015, where a focus search is performed and the beam 200 is focused on the target data layer. Otherwise, execution of step 1013 will be resumed after a certain time period, until adjustment of the SAC value is completed. Afterwards, the process proceeds to step 1017, where the processor 209 controls the pickup control unit 207 to transmit a signal which directs the optical pickup head 203 to move laterally to the target track position in a short jump.

If the optical pickup head 203 has moved to the target track position in step 1011, or step 1017 is performed, the process proceeds to step 1019, where the processor 209 controls the pickup control unit 207 to transmit a signal for controlling the optical pickup head tracking on the optical disc. Next in step 1021, the pickup control unit 207 reads the current track position, after which the processor 209 determines in step 1023 that the current track position is the target position. In this embodiment, if the distance from the current track position to the target track position is smaller than or equal to 1, the current track position will be deemed as the target position. If the distance from the current track position to the target track position is smaller than or equal to 1, then the process proceeds to step 1025 to begin data access. Otherwise, the process returns to step 905 to repeat the above steps.

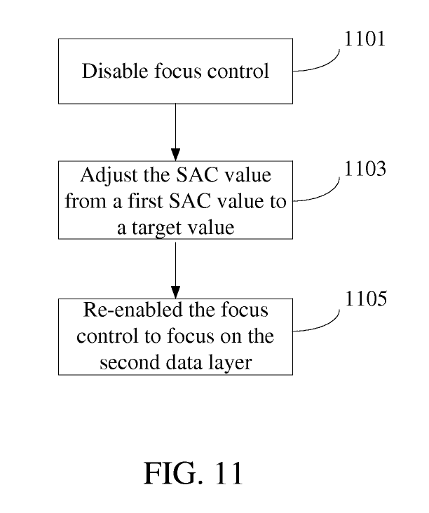

A second embodiment of this invention is a method for changing the data access form a first data layer of a plurality of data layers in an optical storage medium to a second data layer of the same. The method is used in an optical data accessing apparatus as described in the first embodiment. As shown in FIG. 11, this method begins with step 1101, where the focus control is disabled. Then, in step 1103, the SAC value is adjusted from a first SAC value to a target value. After the SAC value has reached the target value, the focus control is re-enabled in step 1105 to focus onto the second data layer.

In addition to the steps shown in FIG. 11, the second embodiment can further execute all the steps of the first embodiment. Those skilled in the art will appreciate how to execute all these steps in the second embodiment upon reviewing corresponding descriptions of the first embodiment, and therefore, no unnecessary detail will be given herein.

Although the above embodiments have been described with reference to an optical storage medium comprising two data layers, this invention is not just limited thereto. Instead, as will be readily appreciated by those skilled in the art from description of the above embodiments, optical storage media comprising more than two data layers are also covered by this invention. Similarly, although the above embodiments have been described with reference to a blu-ray optical disk, it is apparent to those skilled in the art that application of this invention in not limited to data access of a blu-ray optical disk.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A method of data access for changing access from a first data layer to a second data layer between a plurality of data layers of an optical storage medium, for using in an optical data accessing apparatus, the optical data accessing apparatus controlling a beam to generate a focus point on the data layers by a focus control and compensating a spherical aberration of the focus point by a spherical aberration compensator (SAC) value, the first data layer corresponds to a first SAC value, the second data layer corresponds to a second SAC value, the method comprising the steps of:
disabling the focus control;
adjusting the SAC value from the first SAC value to a target value, wherein the target value is between the first SAC value and the second SAC value; and
re-enabling the focus control for controlling the focus point to focus on the second data layer while the SAC value reaches the target value.

2. The method as claimed in claim 1, wherein the step of disabling the focus control further comprises a step of moving the focus point to a predetermined position.

3. The method as claimed in claim 2, wherein the predetermined position is positioned outside the optical storage medium.

4. The method as claimed in claim 2, wherein the predetermined position is positioned on a cover layer of the optical storage medium.

5. The method as claimed in claim 1, wherein the step of re-enabling the focus control further comprises the steps of:
moving the focus point to vertically pass through the optical storage medium;
detecting a focusing error (FE) signal reflected by the focus point passing through the optical storage medium; and
focusing on the second data layer while the FE signal is satisfied with a predetermined condition.

6. The method as claimed in claim 5, wherein the predetermined condition is that a level of the FE signal is greater than a predetermined value or a number of S-curves of the FE signal reaches a predetermined number.

7. The method as claimed in claim 1, further comprising a step of adjusting the SAC value from the target value to the second SAC value while the step of re-enabling the focus control is executed.

8. An optical data accessing apparatus for changing access from a first data layer to a second data layer between a plurality of data layers of an optical storage medium, the first data layer corresponds to a first SAC value, the second data layer corresponds to a second SAC value, the optical data accessing apparatus comprising:
an optical pickup head for generating a beam to focus on the optical storage medium, comprising:
an object lens for controlling a focus point of the beam;
a photodetector for detecting a reflected light reflected from the optical storage medium; and
an SAC for compensating a spherical aberration of the beam according to the SAC values;
a signal processing unit for generating an FE signal according to the reflected light;
a pickup control unit for executing a focus control according to the FE signal to focus the focus point on the data layers; and
a processor for:
generating a focus off signal to the pickup control unit to disable the focus control;
generating a target value for the SAC to adjust the SAC value from the first SAC value to the target value, wherein the target value is between the first SAC value and the second SAC value; and
generating a focus activation signal to the pickup control unit to re-enable the focus control for controlling the focus point to focus on the second data layer while the SAC value reaches the target value.

9. The optical data accessing apparatus as claimed in claim 8, wherein the object lens moves the focus point to a predetermined position while the pickup control unit disables the focus control.

10. The optical data accessing apparatus as claimed in claim 9, wherein the predetermined position is positioned outside the optical storage medium.

11. The optical data accessing apparatus as claimed in claim 9, wherein the predetermined position is positioned on a cover layer of the optical storage medium.

12. The optical data accessing apparatus as claimed in claim 8, wherein the pickup control unit controls the object lens to execute a focus search state for moving the focus point to pass through each vertical position of the optical storage medium while the pickup control unit re-enables the focus control for controlling the focus point in response to the focus activation signal, the processor monitors the FE signal under the focus search state, the pickup control unit controls the object lens to focus on the second data layer while the FE signal is satisfied with a predetermined condition.

13. The optical data accessing apparatus as claimed in claim 12, wherein the predetermined condition is determined according to the second SAC value by the processor.

14. The optical data accessing apparatus as claimed in claim 13, wherein when the SAC value is the second SAC value, the predetermined condition is that a level of the FE signal is greater than a predetermined value or a number of S-curves of the FE signal reaches a predetermined number.

15. The optical data accessing apparatus as claimed in claim 8, wherein the processor controls the SAC to compensate the spherical aberration according to the second SAC value while the pickup control unit re-enables the focus control for controlling the focus point in response to the focus activation signal.

16. A method for data access for changing access from a first storage region of an optical storage medium to a second storage region of the same, for use in an optical data accessing apparatus, the first storage region being positioned in a first data layer of the optical storage medium, the second storage region being positioned in a second data layer of the optical storage medium, the optical data accessing apparatus controlling a beam to generate a focus point on the data layers by a focus control and compensating a spherical aberration of the focus point by an SAC value, the first data layer corresponds to a first SAC value, the second data layer corresponds to a second SAC value, the method comprising the steps of:
disabling the focus control;
determining whether the changing access from the first storage region to the second storage region is a long distance moving;
adjusting the SAC value from the first SAC value to a target value and moving an accessing position of the first storage region to an accessing position of the second storage region when the changing access from the first storage region to the second storage region is the long distance moving, wherein the target value is between the first SAC value and the second SAC value; and
re-enabling the focus control for controlling the focus point to focus on the second data layer while the SAC value reaches the target value.

17. The method as claimed in claim 16, wherein when the changing access from the first storage region to the second storage region is not the long distance moving, the method further comprises the steps of:
adjusting the SAC value from the first SAC value to the target value;
adjusting the SAC value from the target value to the second SAC value; and
moving the accessing position of the first storage region to the accessing position of the second storage region after the SAC value is adjusted to the second SAC value.

18. The method as claimed in claim 16, wherein the step of disabling the focus control further comprises a step of moving the focus point to a predetermined position.

19. The method as claimed in claim 18, wherein the predetermined position is positioned outside the optical storage medium.

20. The method as claimed in claim 18, wherein the predetermined position is positioned on a cover layer of the optical storage medium.

21. The method as claimed in claim 16, wherein the step of re-enabling the focus control further comprises the steps of:
moving the focus point to vertically pass through the optical storage medium;
detecting an FE signal reflected by the focus point passing through the optical storage medium; and
focusing on the second data layer while a level of the FE signal is greater than a predetermined value.

22. The method as claimed in claim 21, wherein when the SAC value is the second SAC value, the level of the FE signal corresponds to a maximum value and a second maximum value, and the predetermined value is determined between the maximum value and the second maximum value.

23. The method as claimed in claim 16, further comprising a step of adjusting the SAC value from the target value to the second SAC value while the step of re-enabling the focus control is executed.

24. An optical data accessing apparatus for changing access from a first storage region of an optical storage medium to a second storage region of the same, the first storage region being positioned in a first data layer of the optical storage medium, the second storage region being positioned in a second data layer of the optical storage medium, the first data layer corresponds to a first SAC value, the second data layer corresponds to a second SAC value, the optical data accessing apparatus comprising:
an optical pickup head for generating a beam to focus on the optical storage medium, comprising:
an object lens for controlling a focus point of the beam;
a photodetector for detecting a reflected light reflected from the optical storage medium; and
an SAC for compensating a spherical aberration of the beam according to the SAC values;
a signal processing unit for generating an FE signal according to the reflected light;
a pickup control unit for executing a focus control according to the FE signal to focus the focus point on the data layers; and
a processor for:
generating a focus off signal to the pickup control unit to disable the focus control;
determining whether the changing access from the first storage region to the second storage region is a long distance moving;
generating a target value for the SAC to adjust the SAC value from the first SAC value to the target value and to move an accessing position of the first storage region to an accessing position of the second storage region when the changing access from the first storage region to the second storage region is the long distance moving, wherein the target value is between the first SAC value and the second SAC value; and
generating a focus activation signal to the pickup control unit to re-enable the focus control for controlling the focus point to focus on the second data layer while the SAC value reaches the target value.

25. The optical data accessing apparatus as claimed in claim 24, wherein when the changing access from the first storage region to the second storage region is not the long distance moving, the processor for:
adjusting the SAC value from the first SAC value to the target value;
adjusting the SAC value from the target value to the second SAC value; and
moving the accessing position of the first storage region to the accessing position of the second storage region after the SAC value is adjusted to the second SAC value.

26. The optical data accessing apparatus as claimed in claim 24, wherein the object lens moves the focus point to a predetermined position while the pickup control unit disables the focus control.

27. The optical data accessing apparatus as claimed in claim 26, wherein the predetermined position is positioned outside the optical storage medium.

28. The optical data accessing apparatus as claimed in claim 26, wherein the predetermined position is positioned on a cover layer of the optical storage medium.

29. The optical data accessing apparatus as claimed in claim 24, wherein the pickup control unit controls the object lens to execute a focus search state for moving the focus point to pass through each vertical position of the optical storage medium while the pickup control unit re-enables the focus control for controlling the focus point in response to the focus activation signal, the processor monitors the FE signal under the focus search state, the pickup control unit controls the object lens to execute a focus on state to focus on the second data layer while the FE signal is greater than a predetermined value.

30. The optical data accessing apparatus as claimed in claim 29, wherein the predetermined value is determined according to the second SAC value by the processor.

31. The optical data accessing apparatus as claimed in claim 30, wherein when the SAC value is the second SAC value, the level of the FE signal corresponds to a maximum value and a second maximum value, and the predetermined value is between the maximum value and the second maximum value.

32. The optical data accessing apparatus as claimed in claim 24, wherein the processor controls the SAC to compensate the spherical aberration according to the second SAC value while the pickup control unit re-enables the focus control for controlling the focus point in response to the focus activation signal.
